(19) United States
(12) Patent Application Publication
(10) Pub. No.: US 2008/0017353 A1
(43) Pub. Date: Jan. 24, 2008

(54) Valve for controlling a coolant flow for a heating element of a motor vehicle and system with at least one valve

(75) Inventor: Nicolae Folea, Ludwigsburg (DE)

Correspondence Address: LEYDIG VOIT & MAYER, LTD, 700 THIRTEENTH ST. NW, SUITE 300, WASHINGTON, DC, 20005-3960, US

(73) Assignee: BEHR GMBH & CO. KG, Stuttgart (DE)

(21) Appl. No.: 11/778,121

(22) Filed: Jul. 16, 2007

(30) Foreign Application Priority Data
Jul. 17, 2006 (DE) 10 2006 033 315.2

(51) Int. Cl. F28F 27/00; F16K 31/02

(52) U.S. Cl. 165/96; 251/129.15

(57) ABSTRACT

The invention pertains to a valve for controlling a coolant flow to a heating element of a motor vehicle that features a first valve opening (2) that serves for supplying coolant to a heating element and can be closed by means of a first controllable closing element (3) and at least one second valve opening (4) that serves for bypassing the heating element and for controlling the pressure and can be closed by means of at least one second closing element (8), wherein the first closing element (3) and the second closing element (8) are arranged in one structural unit.

The present invention pertains to a valve for controlling a coolant flow for a heating element of a motor vehicle according to the preamble of claim 1 and to a system with at least one valve. A heat exchanger, particularly a heating element that usually features a ribbed pipe block of pipes, for example, of flat pipes, is typically utilized for heating the passenger compartment of a motor vehicle, wherein a first medium, particularly a cooling fluid containing water, flows through said heat exchanger. Ribs, corrugated ribs, are arranged adjacent to the pipes, particularly the flat pipes, or integrally connected to the pipes, particularly flat pipes, by means of soldering, welding, bonding, etc. The ribs, particularly the corrugated ribs, as well as the pipes, particularly the flat pipes, transfer heat to a second medium particularly air flowing past the flat pipes and/or the corrugated ribs. The air is heated during this process. The heated air is used for heating the passenger compartment of a motor vehicle.

The first medium, particularly the coolant, such as for example water-containing a cooling fluid or air or another cooling fluid, flows through at least sections of an internal combustion engine of a motor vehicle and cools the internal combustion engine of the motor vehicle during this process. The heat absorbed by the first medium, particularly the coolant, is transferred to air flowing past the first heat exchanger, particularly the heating element, in the above-described fashion. The coolant heated by the internal combustion engine flows from the internal combustion engine to the first heat exchanger, particularly the heating element, in at least one first-line section and then flows through this first heat exchanger within the pipes, particularly the flat pipes, wherein the coolant subsequently flows out of the first heat exchanger, particularly the heating element, and back to the internal combustion engine in a second-line section.

It is also known to provide at least one third-line section for bypassing the first heat exchanger, particularly the heating element. After flowing out of the internal combustion engine, at least part of the first coolant or the entire first coolant can be directly returned to the internal combustion engine through this bypass line.

It is furthermore known to utilize at least one pump such as an electric pump that is arranged in the first-line section or in the second-line section or in the bypass channel and pumps the first medium, particularly the cooling fluid, through the engine.

It is also known to utilize a valve element that controls the flow to the first heat exchanger, particularly the heating element, in such a way that the first medium flows to the first heat exchanger, particularly the heating element, or that the first medium does not flow to this first heat exchanger.

It is furthermore known to utilize two separate valve elements for controlling and/or regulating the flow volume of the first medium, particularly the cooling fluid, through the bypass channel.

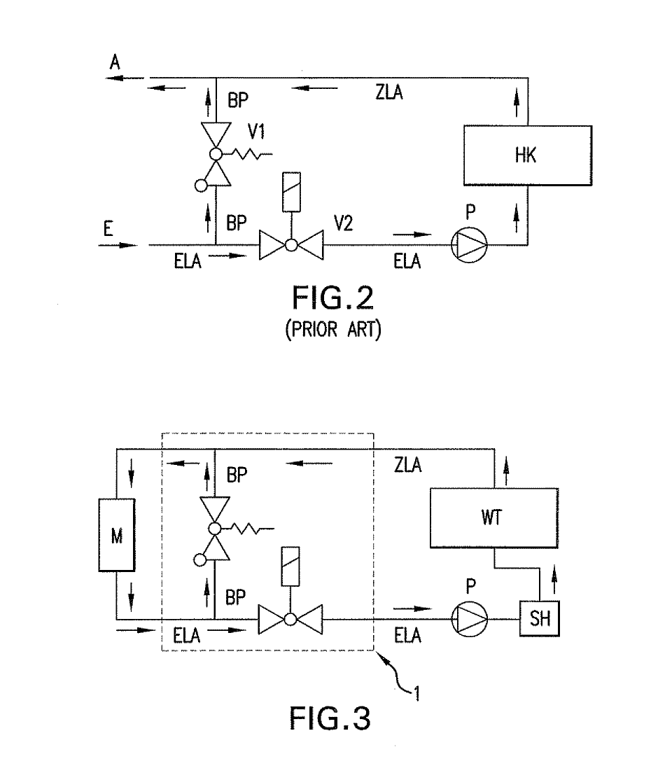

These separate valve elements for controlling the flow of the coolant through the bypass channel and for regulating or controlling the flow to the first heat exchanger, particularly the heating element, require much structural space and a large number of lines for the respective valves; see FIG. 2 (state of the art).

FIG. 2 shows a system according to the state of the art with a first heat exchanger, particularly a heating element HK, as well as a first valve V1 and a second valve V2.

A medium such as a coolant flows into a first-line section ELA through an inlet. A bypass BP branches off the first-line section ELA at a junction. A second valve V2, particularly a magnetically controlled valve, controls the flow of the cooling fluid, for example, a cooling fluid containing water. Depending on the position of the second valve V2, the coolant flows or does not flow to the heating element HK and to the pump P situated upstream of the heating element HK. If the second valve opens, the circulation pump P causes the coolant to flow into the heating element HK, wherein the coolant then flows through this heating element and ultimately to the outlet A. The bypass BP flows into the second-line section ZLA upstream of the outlet. A first valve V1 controls the flow volume of the cooling fluid or coolant through the bypass BP.

The present invention is based on the objective of reducing the structural space required for regulating or controlling the flow to the heat exchanger and for regulating the flow volume of the first fluid through a bypass channel and of simplifying this regulation or control and/or reducing the number of components.

This objective is attained with the characteristics of Claim 1.

The invention proposes a valve for controlling the coolant flow for a heating element of a motor vehicle which features at least one first valve opening that serves for supplying a coolant to the heating element and can be closed by means of a first controllable closing element, as well as a second valve opening that serves for bypassing the heating element and for controlling the pressure and can be closed by means of at least one second closing element, wherein the first closing element and the second closing element are arranged in one structural unit.

The coolant, particularly a cooling fluid containing water, can be supplied to a heating element through the first valve opening. The first valve opening is closable by means of a first controllable closing element or can be closed by means of a first controllable closing element, respectively. In this context, the term “controllable” means that the first closing element is or can be controlled electrically and/or magnetically and/or hydraulically and/or pneumatically. The at least one second valve opening serves, in particular, for bypassing the heating element and/or for controlling the pressure. The term “bypassing” means that the first medium, particularly the cooling fluid, does not flow through the heat exchanger, particularly the heating element, but rather around the heating element and is directly returned to the at least one internal combustion engine. The second valve opening may serve, in particular, for controlling the pressure, namely by decreasing an excessively high pressure in the at least one heat exchanger, particularly the heating element, and/or in at least one line due to the fact that the first medium, particularly the cooling fluid, can be discharged through the second valve opening. The first closing element and the second closing element may be arranged in one structural unit, particularly in a housing.

In one advantageous embodiment, the first closing element is controllable by means of at least one electromagnet and/or at least one coil or can be controlled by means of at least one electromagnet and/or by means of at least one coil or is controlled by means of at least one electromagnet and/or by means of at least one coil. The first closing element therefore is able to open or close the at least one first valve opening in a particularly advantageous fashion.

It may also be preferred, in particular, that the first closing element can be controlled by means of at least one vacuum cell. The first closing element is able to open or close the first valve opening in a particularly advantageous fashion in this case.

It is also possible to at least sectionally realize the first closing element similar to a conical element and/or with a pin-like guide region. The first valve opening can be advantageously closed in a particularly tight fashion in this case. The first closing element furthermore is able to close the at least one first valve opening in a particularly advantageous fashion.

In another advantageous additional development, the pin-like region is at least sectionally arranged in a complementary guide element. The first closing element can be guided in a particularly advantageous fashion in this case.

Another advantageous embodiment is characterized in that a first spring element is at least sectionally arranged on the complementary guide element in order to open the first valve opening when the electromagnet is in a currentless state and/or when the coil is in a currentless state. This advantageously makes it possible to prevent the first valve opening from remaining closed and, in particular, the heating power from remaining low in the currentless state, particularly in case of a power failure.

It is also possible to at least sectionally connect the second closing element to a second spring element and/or to realize the second closing element in such a way that the second opening is at least sectionally open if a pressure limit is exceeded. This advantageously makes it possible to discharge the first medium, particularly the coolant, through the bypass if a pressure limit is exceeded.

The invention furthermore proposes a system with at least one valve that features at least a first heat exchanger, particularly a heating element, for heating a passenger compartment of a motor vehicle and at least one second heat exchanger, in particular, for heating a rear passenger compartment.

It is particularly preferred that the system feature at least a third heat exchanger for heating a passenger compartment while the internal combustion engine is shut off. This advantageously makes it possible to also heat the passenger compartment by means of an auxiliary heater while the internal combustion engine is shut off.

It is furthermore possible that the system feature at least one pump, particularly an auxiliary pump, for pumping a first medium that serves for cooling the engine and/or for heating the passenger compartment and/or at least one bypass line for bypassing at least the first heat exchanger. The first heat exchanger, particularly the heating element, can be supplied with the first medium, particularly the coolant, in a particularly advantageous fashion in this case.

Other advantageous embodiments of the invention are disclosed in the dependent claims and in the figures. The objects of the dependent claims pertain to the inventive valve for controlling a coolant flow for a heating element of a motor vehicle, as well as to the inventive system with at least one valve.

Embodiments of the invention are illustrated in the figures and are described in greater detail below, wherein the invention is not limited only to these embodiments. Shown:

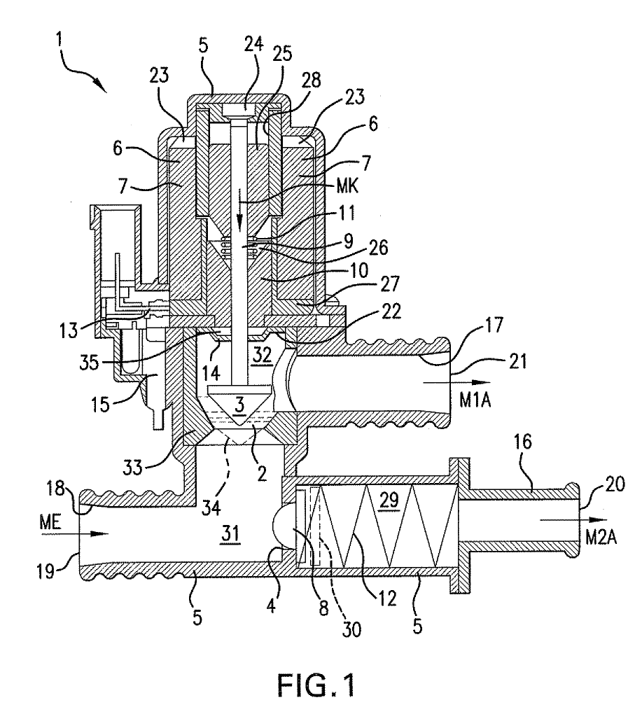

FIG. 1, a valve for controlling the coolant flow for a heat exchanger, particularly a heating element, of a motor vehicle;

FIG. 2, a system according to the state of the art with a first heat exchanger and with a first valve and a second valve;

FIG. 3, a system with a valve for controlling a coolant flow for a heat exchanger, particularly a heating element, of a motor vehicle, and

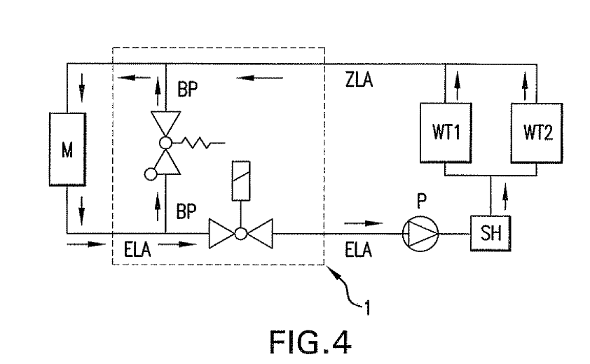

FIG. 4, another embodiment of a system with a valve for controlling a coolant flow for a first heat exchanger and a second heat exchanger.

FIG. 1 shows a valve 1 for controlling a coolant flow for a heat exchanger, particularly a heating element, of a motor vehicle.

The valve 1 features a valve housing 5. A supply connection 18 for supplying a coolant and a heating element connection 17 are arranged on the valve housing 5. In addition, a bypass connection 16 is arranged on the valve housing 5. In the embodiment shown, the supply connection 18 and/or the heating element connection 17 and/or the bypass connection 16 is/are realized in one piece with the valve housing 5. In another embodiment, the bypass connection 16 and/or the heating element connection 17 and/or the supply connection 18 is/are connected to the valve housing 5 integrally, particularly by means of welding, soldering, bonding, etc., and/or positively.

In the embodiment shown, the valve housing 5 is made of plastic. In another embodiment, the valve housing 5 is made of metal such as aluminum or special steel, or of ceramics or a composite fiber material. The valve housing 5 is manufactured, for example, by means of a primary forming method such as injection molding or diecasting. In another embodiment, the valve housing 5 is manufactured by means of a forming method such as pressing or punching.

The bypass connection 16 is at least sectionally realized in a tubular fashion and features a bypass connection opening 20. The bypass connection is realized in a flange-shaped fashion on the end of the bypass connection that lies opposite the bypass connection opening 20. On the flange-shaped section that is not separately identified, the bypass connection 16 is connected to the valve housing 5 positively, particularly by means of a screw connection, and/or to the valve housing 5 integrally, particularly by means of soldering, welding, bonding, etc. A not-shown hose element or pipe element is pushed over the bypass connection 16 and fixed on the bypass connection 16, for example, by means of a hose clamp. In another embodiment, the not-shown hose element or pipe element may be connected to the bypass connection 16 positively and/or integrally. A projection formed by the bypass connection not separately identified is arranged adjacent to the bypass connection opening 20, wherein this projection serves, in particular, for improving the retention of the pipe element or hose element pushed onto the bypass connection 16.

An essentially cylindrical first valve housing chamber of the first valve housing 5, in which the second closing element 8 as well as the second spring element 12 are arranged, is situated adjacent to the bypass connection. The first valve housing chamber 29 features a first opening that is not separately identified and that is arranged adjacent to the bypass connection 16. The valve housing 5 furthermore features a second valve opening 4 that is realized, in particular, in the form of a valve seat for the second closing element 8. In the embodiment shown, the first valve housing chamber 29 has a larger diameter than the bypass connection 16. This results, in particular, in a limit stop for the second spring element 12 being formed between the first housing chamber 29 and the bypass connection 16. In another embodiment, the bypass connection has a larger diameter than the first valve housing chamber 29. In yet another embodiment, the first valve housing chamber 29 has the same diameter as the bypass connection 16.

In the embodiment shown, the second spring element 12 is essentially realized in the form of a coil spring. In another embodiment, the second spring element 12 is realized, for example, in the form of a leaf spring element or another spring element.

The second closing element 8 is essentially realized in the form of a circular plate element, on which a knob is realized. If the inlet to the bypass is closed, an annular section of the second closing element 8 that is not separately identified adjoins a section of the valve housing 5. The knob-shaped section of the second closing element 8 is essentially arranged in the second valve opening 4. If the bypass channel is open, the second closing element assumes, for example, the position 30, in which the second closing element is illustrated with broken lines. A medium such as a coolant, particularly a cooling fluid containing water, can then flow into the first valve housing chamber 29 through the second valve opening 4, wherein the medium can flow out of the valve 1 in the direction of the second medium outlet opening M2A through the bypass connection 16 and then into the not-shown bypass channel.

In another embodiment, the second closing element 8 has an at least sectionally conical and/or cylindrical shape or a shape that represents a combination of the aforementioned shapes. A second valve housing chamber 31 is situated adjacent to the first valve housing chamber 29. The first coolant, particularly a cooling fluid containing water, flows by way of the media inlet direction into the second valve housing chamber 31 through the inlet opening 19 of the supply connection 18. In the embodiment shown, the supply connection 18 features at least sectionally round grooves that are not separately identified and that are peripherally arranged around the supply connection 18. A hose element or pipe element can be pushed on the supply connection 18 in this fashion. The pipe element or hose element that is not separately identified is advantageously prevented from separating in this fashion. In addition, the not-shown hose element can be secured on and/or connected to the supply connection 18, for example, by means of a hose clamp. An essentially annular element 33 is placed into the valve housing 5 or, according to another embodiment, is realized integrally with the valve housing 5. The annular element 33 contains the first valve opening 2. The first valve opening 2 is realized, in particular, in the form of an at least sectionally conical valve seat for the first closing element 3. A third valve housing chamber 32 is arranged adjacent to the second valve housing chamber 31 and is separated by the first valve opening 2. When the first closing element 3 is open, a coolant such as a water-containing cooling fluid or air can flow into the third valve housing chamber 32 through the first valve opening 2 and out of the third valve housing chamber in the direction of the first medium outlet direction M1A through the heating element connection opening 21 of the heating element connection 17, wherein the coolant can subsequently flow, for example, to the not-shown heat exchanger, particularly to the not-shown heating element. The first closing element 3 is illustrated in the closed position 34 with broken lines.

The first closing element 3 is realized in a conical fashion. A first guide element 9 is arranged adjacent to the conical section. The first closing element 3 and the first guide element 9 are realized in one piece in the embodiment shown. In another embodiment, the first closing element 3 and the first guide element 9 may be connected integrally, particularly by means of welding, soldering, bonding, etc., and/or positively. The first guide element 9 is essentially realized in the form of a pin element. In another embodiment, the first closing element 3 is realized cylindrically and has a round or oval or triangular or polygonal cross-sectional surface or a cross-sectional surface that represents a combination of the aforementioned shapes.

A second guide element 25 is at least sectionally arranged on the first guide element 9. The second guide element 25, in particular, is shrunk on the first guide element 9 or connected to the first guide element 9, for example, by means of an integral connection. The second guide element 25 is essentially realized in the form of a cylindrical cone element.

The first closing element 3 assumes a first end position when the first guide element 9 contacts the first stopping face 24 of the cylindrical housing. The first stopping face 24 may be, for example, part of a rubber element or another damping element for damping the first guide element 9. The conical element of the second guide element 25 contacts the corresponding conical surface of the complementary guide element 10, in particular, in the closed position 34 of the first closing element 3. The complementary guide element 10 features a bore that is not separately identified and that essentially accommodates the first guide element 9. The first guide element 9 is at least sectionally guided in the bore of the complementary guide element 10 in this fashion. The complementary guide element 10 is realized in one piece with the valve housing 5 or, according to another embodiment, is connected to the valve housing 5 positively and/or integrally. A first spring element 11 is arranged between the second guide element 25 and the complementary guide element 10. The first spring element 11 may be realized, for example, in the form of a coil spring or a leaf spring. The first spring element 11 is also arranged on the first guide element 9. When the first closing element 3 is situated, in particular, in the closed position 34, the first spring element 11 is pretensioned in such a way that a spring force acts upon the second guide element 25 as well as the guide element 10 in the currentless state of the valve 1, wherein this causes the second guide element 25 and the complementary guide element 10 to be pressed apart and the first closing element to release the first valve opening. Consequently, it is ensured that the first medium, particularly a coolant such as the cooling fluid containing water, can flow out of the heating element connection 17 in the direction of the first medium outlet direction M1A through the heating element connection opening 21 in the currentless state. The first guide element 9 and the second guide element 25 are made, for example, of a material that can be magnetized, for example, a metal, particularly iron or aluminum or steel. A coil 6 and an electromagnet 7 are arranged in the valve housing 5 essentially concentric to the first guide element 9 and/or the second guide element 25. The coil 6 and the electromagnet 7 are supplied with power by means of an electric connection. If current is supplied to the coil 6 and the electromagnet, respectively, the magnetic force MK being generated moves the first closing element 3 and the first guide element 9 in the direction of the magnetic force MK such that the first closing element 3 assumes the closed position 34 and closes the first valve opening 2. The first closing element 3 is made, for example, of a material such as rubber or another sealing material such that no medium, for example, a coolant, can penetrate into the third valve housing chamber 32 from the second valve housing chamber 31 through the first valve opening 2 in the closed position 34 of the first closing element 3.

In addition, a membrane 14 is arranged on the first guide element 9 in such a way that it clears dirt off the first guide element 9 and simultaneously seals the chamber 32 relative to a fourth valve housing chamber 35. The fourth valve housing chamber 35 contains, in particular, the electromagnet 7 as well as the coil 6, the first spring element 11 and the second guide element 2. The membrane 14 contains an opening that essentially corresponds to the cross-sectional surface of the first guide element 9. The membrane 14 is made, for example, of rubber or another sealing material. In the embodiment shown, the membrane 14 is realized in one piece with a first sealing element 22. In another embodiment, the first sealing element 22 and the membrane 14 are not realized in one piece. The first sealing element 22 is made, for example, of rubber or another sealing material and prevents the medium situated in the third valve housing chamber 32 from penetrating into the fourth valve housing chamber 35 and damaging, for example, the coil 6 or the at least one electromagnet 7 and the electric connections 13 due to the admission of a fluid, particularly the coolant or another medium, into the fourth valve housing chamber 35. At least one second sealing element 23 and/or at least one third sealing element 27 also prevent the medium such as a coolant in the form of a cooling fluid containing water from reaching and damaging the at least one electromagnet and the at least one coil 6.

The valve 1 can assume the following positions:

The first closing element 3 may be arranged in the closed position 34, and the second closing element 8 may also be arranged in the closed position. A medium such as a cooling fluid then flows into the second valve housing chamber 31 in the direction of the media inlet direction ME through the inlet connection opening 19 via the inlet connection 18, but can neither penetrate into the first valve housing chamber 29 nor into the third valve housing chamber 32.

If the first closing element 3 is in the closed position 34 and the second closing element 8 is in the open position 30, a first medium such as a cooling fluid or another coolant, can flow into the second valve housing chamber 31 through the inlet connection opening 19 of the inlet connection 18, as well as into the first housing chamber 29 through the open second valve opening 4 and into the bypass through the bypass connection opening 20.

If the first closing element 3 is opened, i.e., if the first valve opening 2 is opened, and the second closing element 8 is closed, i.e., if the second valve opening 4 is closed, a first medium such as a cooling fluid or another coolant such as air, can flow into the inlet connection 18 through the inlet connection opening 19 and consequently into the second valve housing chamber 31, wherein the medium is also able to flow into the third valve housing chamber 32 through the first valve opening 2 and into the heating element connection 17 with the heating element connection opening 21 such that it can ultimately flow to the heating element through the heating element connection opening 21. In this case, no medium can penetrate into the first valve housing chamber 29.

If the first closing element 3 is opened and the second closing element 8 is also opened and therefore situated in the open position 30, the medium such as a water-containing cooling fluid or air or another coolant can flow into the second valve housing chamber 31 through the inlet connection 18 and the inlet connection opening 19, as well as into the first valve housing chamber 29 through the second valve opening 4, wherein the medium can then flow to the bypass as well as into the third valve housing chamber 32 and ultimately to the heating element or another heat exchanger through the heating element connection opening 21.

The valve for controlling the coolant flow protects the at least one heat exchanger, particularly the heater, from excessive pressure and/or cavitation and an excessively high flow volume of the first medium, particularly the coolant. The valve furthermore fulfills a differential pressure control function in order to control the coolant flow. The valve for controlling the coolant flow also makes it possible, in particular, to realize an unlimited flow of the first medium, particularly a coolant, through the bypass.

The valve for controlling the coolant flow also makes it possible to switch over between a medium flow, particularly a coolant flow, through the bypass and through the at least one heat exchanger, particularly the heating element.

FIG. 3 shows a system with an inventive valve 1 for controlling the coolant flow to a heat exchanger, particularly a heating element HK, as well as for controlling the bypass channel BP. Identical characteristics are identified by the same reference symbols as in the preceding figures.

The system features an internal combustion engine M, the inventive valve 1, a pump P for pumping the coolant such as a cooling fluid containing water and a heat exchanger WT. In another embodiment, the system may also feature an auxiliary heater SH.

In the embodiment shown, the heat exchanger WT consists of a heating element. In another embodiment, the heat exchanger WT is realized in the form of a coolant cooler and/or an exhaust gas cooler and/or a charge air cooler and/or a condenser for an air-conditioning system and/or a gas cooler for an air-conditioning system and/or an oil cooler and/or an evaporator for an air-conditioning system.

A second heat exchanger for cooling the internal combustion engine is arranged in the internal combustion engine M. After the coolant such as a water-containing cooling fluid or air flows through the second heat exchanger in order to cool the internal combustion engine, the coolant heated in the internal combustion engine M flows to the inventive valve 1. We refer to FIG. 1 with respect to the functions of the valve 1. A first-line section ELA leads from the internal combustion engine M to the valve 1 and then to the pump P. The pump P pumps the coolant through the system. In the embodiment shown, the first-line section continues to a third heat exchanger SH, particularly to an auxiliary heater, and then to the heat exchanger WT, particularly the heating element. In another embodiment, the coolant flows directly to the first heat exchanger WT, particularly the heating element, through the first-line section ELA after flowing through the pump P. After flowing through the first heat exchanger WT, particularly the heating element, the coolant flows to the internal combustion engine M, particularly to the second heat exchanger for cooling the internal combustion engine that is arranged in the internal combustion engine M, namely through a second-line section ZLA. The bypass BP leads into the second-line section ZLA. The valve for controlling the coolant flow protects the at least one heat exchanger, particularly the heater, from excessive pressure and/or cavitation if the volume flow of the first medium, particularly the coolant, is excessively high. The valve for controlling the coolant flow furthermore fulfills a differential pressure control function. The valve for controlling the coolant flow also makes it possible, in particular, to realize an unlimited flow of the first medium, particularly the coolant, through the bypass.

FIG. 4 shows a system with an inventive valve 1 for controlling the coolant supply. In contrast to FIG. 3, at least one other heat exchanger WT2, particularly a coolant cooler and/or an exhaust gas cooler and/or a charge air cooler and/or a condenser for an air-conditioning system and/or a gas cooler for an air-conditioning system and/or an oil cooler and/or an evaporator for an air-conditioning system is provided in addition to the first heat exchanger WT1, particularly the heating element.

The characteristics of the different embodiments can be arbitrarily combined with one another. The invention is also suitable for use in fields other than those described above.

1. A valve for controlling a coolant flow for a heating element of a motor vehicle, comprising a first valve opening for supplying coolant to a heating element, the first valve opening being closeable by a first controllable closing element; and at least a second valve opening for bypassing the heating element and for controlling the pressure, the second valve opening being closeable by at least a second closing element, wherein the first closing element and the second closing element are arranged in one structural unit.

2. The valve according to claim 1, wherein the first closing element is controllable by at least one electromagnet and/or at least one coil.

3. The valve according to claim 1 wherein the first closing element is controllable by at least one vacuum cell.

4. The valve according to claim 1 wherein the first closing element is at least sectionally arranged similar to a conical element and/or includes a pin-like guide region.

5. The valve according to claim 4 wherein the pin-like region is at least sectionally arranged in a complementary guide element.

6. The valve according to claim 4 wherein the first closing element can be controlled by at least one electromagnet and/or at least one coil, the valve further comprising a first spring element that is at least sectionally arranged on a complimentary guide element in order to open the first valve opening while the electromagnet is in the currentless state and/or the coil is in the currentless state.

7. The valve according to claim 1, wherein the second closing element is at least sectionally connected to a second spring element and/or the second closing element is arranged such that the second opening is at least sectionally open when a pressure limit is exceeded.

8. A system with at least one valve according to claim 1, further comprising at least a first heat exchanger (WT) for heating a passenger compartment of a motor vehicle and at least a second heat exchanger for cooling an internal combustion engine (M) of a motor vehicle.

9. The system according to claim 8, further comprising at least a third heat exchanger (SH) for heating a passenger compartment while the internal combustion engine (M) is shut off.

10. The system according to claim 8, comprising at least one pump (P) for pumping a first medium in order to cool the engine and/or heat the passenger compartment and/or at least one bypass line (BP) for bypassing at least the first heat exchanger (WT).

11. The valve according to claim 2 wherein the first closing element is controllable by at least one vacuum cell.

12. The valve according to claim 2, wherein the second closing element is at least sectionally connected to a second spring element and/or the second closing element is arranged such that the second opening is at least sectionally open when a pressure limit is exceeded.

13. The valve according to claim 2 characterized by the fact that a first spring element that is at least sectionally arranged on a complimentary guide element in order to open the first valve opening while the electromagnet is in the currentless state and/or the coil is in the currentless state.
